(19) United States
(12) Patent Application Publication
(10) Pub. No.: US 2026/0167063 A1
(43) Pub. Date: Jun. 18, 2026

(54) SEAT ASSEMBLY WITH OPEN MIDGATE CONFIGURATION

(71) Applicant: NISSAN NORTH AMERICA, INC., Franklin, TN (US)

(72) Inventors: Andre OLIVEIRA FERNANDES, Walled Lake, MI (US); Tracy SPAGNUOLO, Brighton, MI (US); Mitsuyasu HIKOSAKA, Novi, MI (US); Devon Michael VOGT, Brighton, MI (US)

(21) Appl. No.: 18/986,507

(22) Filed: Dec. 18, 2024

(51) Int. Cl. B60N 2/02; B60N 2/36; B60N 2/64; B60N 2/90; B62D 33/027

(52) U.S. Cl. CPC B60N 2/0292; B60N 2/64; B60N 2/929; B62D 33/027; B60N 2002/363

(57) ABSTRACT

Vehicles and seat assemblies with open midgate configurations are disclosed herein. In an embodiment, a vehicle includes a passenger cabin, a vehicle seat inside the passenger cabin, a cargo bed and a midgate. The vehicle seat includes a seat bottom and a seat backrest. The seat backrest is configured to slide horizontally over the seat bottom to move between a forward configuration and a rearward configuration. The cargo bed is located on the rear side of the passenger cabin. The midgate is configured to move between (i) an open configuration in which the passenger cabin is open to the cargo bed, the seat backrest is in the forward configuration, and the midgate is located above the seat bottom, (ii) and a closed configuration in which the passenger cabin is closed off from the cargo bed by the midgate and the seat backrest is in the rearward configuration.

### BACKGROUND

### Field of the Disclosure

The present disclosure generally relates to a seat assembly with an open midgate configuration. The present disclosure also generally relates to a seat assembly that forms a forward-facing seat when the midgate is closed and a rearward-facing seat when the midgate is open.

### Background Information

Pickup trucks are known for their usefulness in moving cargo such as lumber, furniture, other commercial items and personal items. To make room for a cargo bed, pickup trucks typically have small passenger cabins with limited space. Some pickup trucks have extended passenger cabins with a second row of seats, but the second row of seats is typically confined to an area with little to no versatility.

### SUMMARY

The present disclosure provides a versatile vehicle seat that maximizes space in the passenger cabin of a pickup truck and can be converted into a rearward-facing seat open to the cargo bed. The vehicle seat and certain of the mechanisms described herein can also be advantageously applied other types of vehicles besides pickup trucks to maximize space and versatility.

In view of the state of the known technology, one aspect of the present disclosure is to provide a vehicle having a passenger cabin, a vehicle seat, a cargo bed and a midgate. The passenger cabin has a front side and a rear side. The vehicle seat is located inside the passenger cabin. The vehicle seat includes a seat bottom and a seat backrest. The seat backrest is configured to slide horizontally over the seat bottom to move between a forward configuration and a rearward configuration. The cargo bed is located on the rear side of the passenger cabin. The midgate is located between the passenger cabin and the cargo bed and configured to move between (i) an open configuration in which the passenger cabin is open to the cargo bed, the seat backrest is in the forward configuration, and the midgate is located above the seat bottom, (ii) and a closed configuration in which the passenger cabin is closed off from the cargo bed by the midgate and the seat backrest is in the rearward configuration.

A second aspect of the present disclosure is to provide another vehicle having a passenger cabin, a vehicle seat, a cargo bed and a midgate. The passenger cabin has a front side and a rear side. The cargo bed is located on the rear side of the passenger cabin. The midgate is located between the passenger cabin and the cargo bed. The midgate is configured to move between an open configuration in which the passenger cabin is open to the cargo bed and a closed configuration in which the passenger cabin is closed off from the cargo bed by the midgate. The vehicle seat is located inside the passenger cabin facing the front side and includes a seat bottom and a seat backrest. The seat backrest is configured to move with respect to the seat bottom so that the midgate is located above the seat bottom but not above the seat backrest when the midgate is in the open configuration.

A third aspect of the present disclosure is to provide another vehicle having a passenger cabin, a vehicle seat, a cargo bed and a midgate. The passenger cabin has a front side and a rear side. The cargo bed is located on the rear side of the passenger cabin. The midgate is located between the passenger cabin and the cargo bed. The midgate is configured to move between an open configuration in which the passenger cabin is open to the cargo bed and a closed configuration in which the passenger cabin is closed off from the cargo bed by the midgate. The vehicle seat is located inside the passenger cabin and includes a seat bottom and a seat backrest. The seat backrest is configured to move between a forward configuration and a rearward configuration.

Other objects, features, aspects and advantages of the systems and methods disclosed herein will become apparent to those skilled in the art from the following detailed description, which, taken in conjunction with the annexed drawings, discloses exemplary embodiments of the disclosed systems and methods.

### BRIEF DESCRIPTION OF THE DRAWINGS

Referring now to the attached drawings which form a part of this original disclosure:

FIG. 1 is a rear perspective view of an example embodiment of a vehicle in accordance with the present disclosure;

FIG. 2 is a side elevational view of the vehicle of FIG. 1;

FIG. 3 is a side elevational view looking into the vehicle at Section A of FIG. 2 and showing an example embodiment of a vehicle seat assembly in accordance with the present disclosure positioned as a forward-facing seat within the vehicle;

FIG. 4 is a side elevational view looking into the vehicle at Section A of FIG. 2 and showing the vehicle seat assembly positioned as a rearward-facing seat within the vehicle;

FIG. 5 is a front perspective view of the vehicle seat assembly positioned as a forward-facing seat;

FIG. 6 is a rear perspective view of the vehicle seat assembly positioned as the forward-facing seat;

FIG. 7 is a rear perspective view of the vehicle seat assembly as the forward-facing seat is converted to a rearward-facing seat;

FIG. 8 is another a rear perspective view of the vehicle seat assembly as the forward-facing seat is converted to the rearward-facing seat;

FIG. 9 is a rear perspective view of the vehicle seat assembly positioned as the rearward-facing seat;

FIG. 10 is a rear perspective view of the vehicle seat assembly showing a drawer space enabled for both the forward-facing seat and the rearward-facing seat by the mechanisms of the vehicle seat assembly;

FIG. 11 is a side elevational view of certain parts of the vehicle seat assembly with the seat backrest in the rearward configuration and the seat bottom lowered;

FIG. 12 is a side elevational view of certain parts of the vehicle seat assembly with the seat backrest in the rearward configuration and the seat bottom raised;

FIG. 13 is a side elevational view of certain parts of the vehicle seat assembly with the seat backrest in the forward configuration;

FIG. 14 is a front perspective view of certain parts of the vehicle seat assembly enabling the seat backrest to move between the forward configuration and the rearward configuration; and

FIG. 15 is a front elevational view of certain parts of the vehicle seat assembly enabling the seat backrest to move between the forward configuration and the rearward configuration.

### DETAILED DESCRIPTION

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

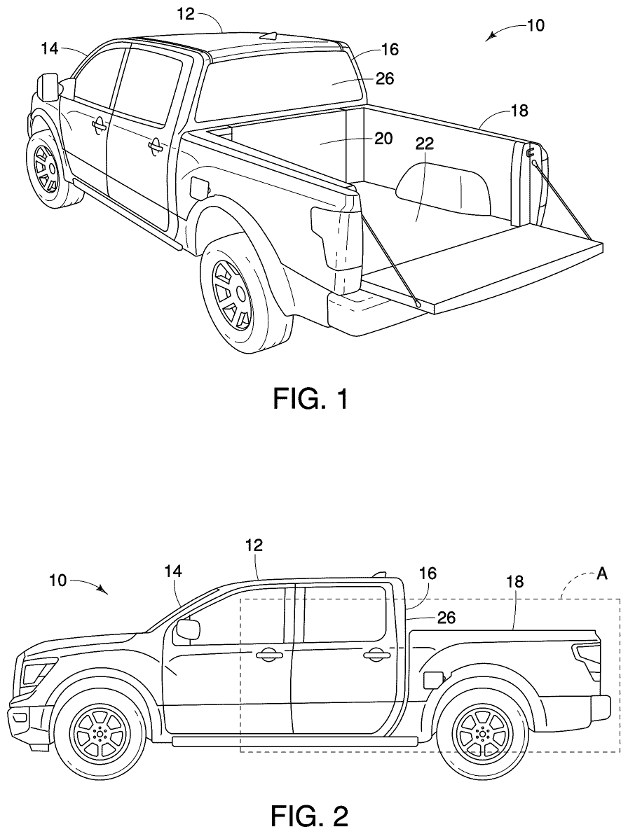

FIGS. 1 to 4 illustrate an example embodiment of a vehicle 10 in accordance with the present disclosure. The vehicle 10 includes a passenger cabin 12 having a front side 14 and a rear side 16, a cargo bed 18 located on the rear side 16 of the passenger cabin 12, a midgate 20 located between the passenger cabin 12 and the cargo bed 18, and a vehicle seat assembly (or “vehicle seat”) 100 located inside the passenger cabin 12. The illustrated vehicle seat 100 is the back row of a pickup truck having an extended passenger cabin 12, but the vehicle seat 100 and its assemblies and mechanisms disclosed herein can be applied to the vehicle seats in any pickup truck, as well to vehicle seats in other types of vehicles 10.

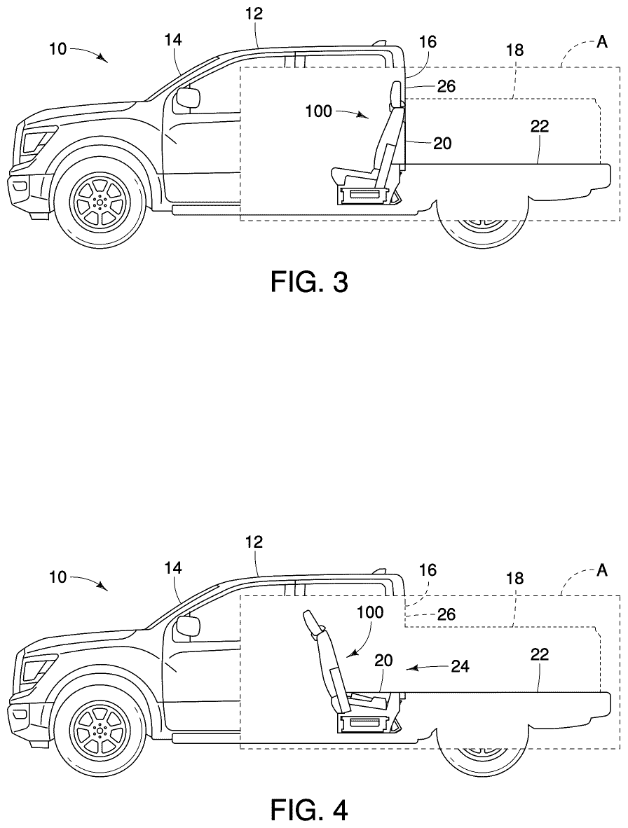

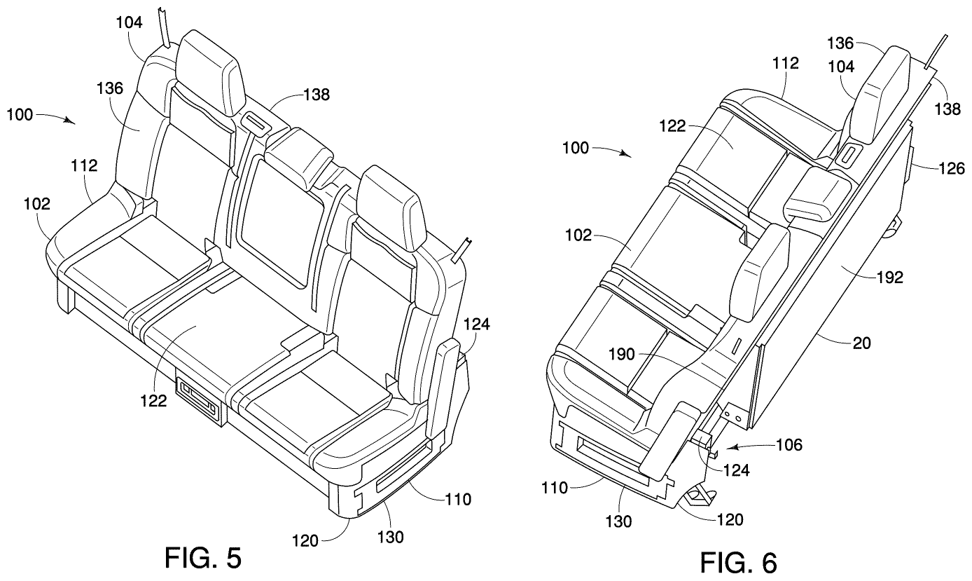

The midgate 20 of the vehicle 10 is configured to move between a closed configuration and an open configuration. FIG. 3 shows the closed configuration in which the passenger cabin 12 is closed off from the cargo bed 18 by the midgate 20. FIG. 4 shows the open configuration in which the passenger cabin 12 is open to the cargo bed 18. The vehicle seat 100 forms a forward-facing seat when the midgate 20 is in the closed configuration (FIG. 3) and a rearward-facing seat when the midgate 20 is in the open configuration (FIG. 4).

As seen in FIG. 4, the midgate 20 itself forms part of the rearward-facing seat when the midgate 20 is in the open configuration. The cargo bed 18 includes a cargo bed floor 22, and the midgate 20 is approximately level with the cargo bed floor 18 when the midgate 20 is in the open configuration, with an open space 24 created between the passenger cabin 12 and the cargo bed 18 which exposes the passenger cabin 12 to the outside environment. The rear side 16 of the passenger cabin 12 can further include a moveable or removeable rear window or other panel 26 to increase the height of the open space 24 when the midgate 20 is in the open configuration. The operator or passengers of the vehicle 10 can thus convert the vehicle seat 100 to the rearward-facing seat configuration shown in FIG. 4, and sit facing the cargo bed 18, exposed to the outside environment, making the vehicle 10 and its vehicle seat 100 advantageous for camping or other outdoor activities. The open configuration can also be used to increase space in the cargo bed 18 for cargo such as lumber or other large items that are longer than the length of the cargo bed floor 22.

FIGS. 5 to 10 illustrate the vehicle seat 100 in more detail. In the illustrated embodiment, the vehicle seat 100 generally includes a seat bottom 102, a seat backrest 104 and a movement mechanism 106. The illustrated vehicle seat 100 also includes a tray 108. The seat backrest 104 extends upward from the seat bottom 102. The seat bottom 102, the seat backrest 104, and the tray 108 generally extend laterally from a first lateral side 110 of the vehicle seat 100 to a second lateral side 112 of the vehicle seat 100 to form a bench seat for multiple passengers. As used herein, the lateral direction generally refers to the sideways direction of the vehicle 10 and vehicle seat 100. As discussed in more detail below, the illustrated vehicle seat 100 includes two movement mechanisms 106, one on the first lateral side 110 and one on the second lateral side 112, which connect the seat backrest 104 to the seat bottom 102 and enable movement of the seat backrest 104 with respect to the seat bottom 102.

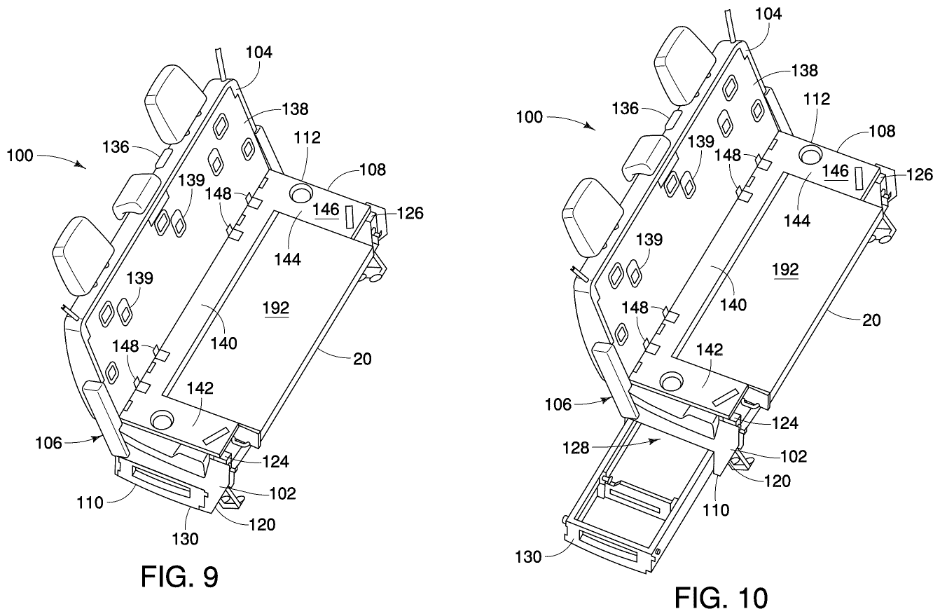

The seat backrest 104 is configured to move between a first (or forward) configuration and a second (or rearward) configuration. This movement enables the midgate 20 to move between the closed configuration and the open configuration without contacting the seat backrest 104. The seat backrest 104 and the seat bottom 102 form the forward-facing seat facing the front side 14 of the passenger cabin 12 when the seat backrest 102 is in the rearward configuration and the midgate 20 is in the closed configuration. The seat backrest 104 and the midgate 20 form the rearward-facing seat facing the rear side 16 of the passenger cabin 12 when the seat backrest 104 is in the forward configuration and the midgate 20 is in the open configuration. Thus, in the closed configuration shown in FIGS. 3 and 5, the passenger cabin 12 is closed off from the cargo bed 18 by the midgate 20, and the seat backrest 104 is in the rearward configuration. In the open configuration shown in FIGS. 4 and 9, the passenger cabin 12 is open to the cargo bed 18, the seat backrest 104 is in the forward configuration, and the midgate 20 is located above the seat bottom 102.

The seat bottom 102 includes a base 120 and an upper surface 122. In the illustrated embodiment, the base 120 includes a first support 124, a second support 126, and an inner space 128. The base 120, the upper surface 122 and the inner space 128 all generally extend from the first lateral side 110 to the second lateral side 112 of the vehicle seat 100. The seat backrest 104 moves over the upper surface 122 of the seat bottom 102 to permit the midgate 20 to move from the closed configuration to the open configuration, and vice versa. The base 120, the upper surface 122, the first support 124 and the second support 126 remain stationary within the vehicle 10 as the seat backrest 104 and/or the midgate 20 move between the different configurations as described herein. By minimizing the moving parts of the vehicle seat 100, the vehicle seat 100 can be made less susceptible to breakage after continued use and the passenger cabin 12 requires less room for moving parts.

The seat backrest 104 includes a front surface 136 and a rear surface 138, which also generally extend from the first lateral side 110 to the second lateral side 112 of the vehicle seat 100. The front surface 136 acts as the backrest for the forward-facing seat (e.g., as seen in FIGS. 3 and 5), while the rear surface 138 acts as the backrest for the rearward facing seat (e.g., as seen in FIGS. 4 and 9). In the illustrated embodiment, the front surface 136 includes cushioning and the rear surface 138 does not, but cushioning can also be added to the rear surface 138. The tray 108 is pivotally attached to a lower portion of the rear surface 138. In the illustrated embodiment, the rear surface 138 of the backrest 104 further includes USB or other outlets 139.

FIGS. 5 to 10 illustrate the process of converting the vehicle seat 100 from the forward-facing seat with the midgate 20 closed to the rearward-facing seat with the midgate 20 opened, and vice versa. Although one embodiment of an adjustable vehicle seat 100 is shown in FIGS. 5 to 10, those of ordinary skill in the art will recognize from this disclosure that certain mechanisms of the vehicle seat 100 described herein can be applied to other adjustable vehicle seats without departing from the spirit and scope of the present disclosure. For example, the reversible seat elements without the movable midgate 20 can be advantageously applied to other types of vehicles 10 that do not have a midgate 20. In another example embodiment, the midgate 20 can be replaced with a platform that does not open to the outside environment.

In FIGS. 5 and 6, the seat backrest 104 is in the rearward configuration and the vehicle seat 100 is configured as a forward-facing seat which faces the front side 14 of the passenger cabin 12. FIG. 6 also shows the positioning of the midgate 20 for reference. In this configuration, the midgate 20 is closed and the passenger cabin 12 is closed off from the cargo bed 18 as seen in FIG. 3.

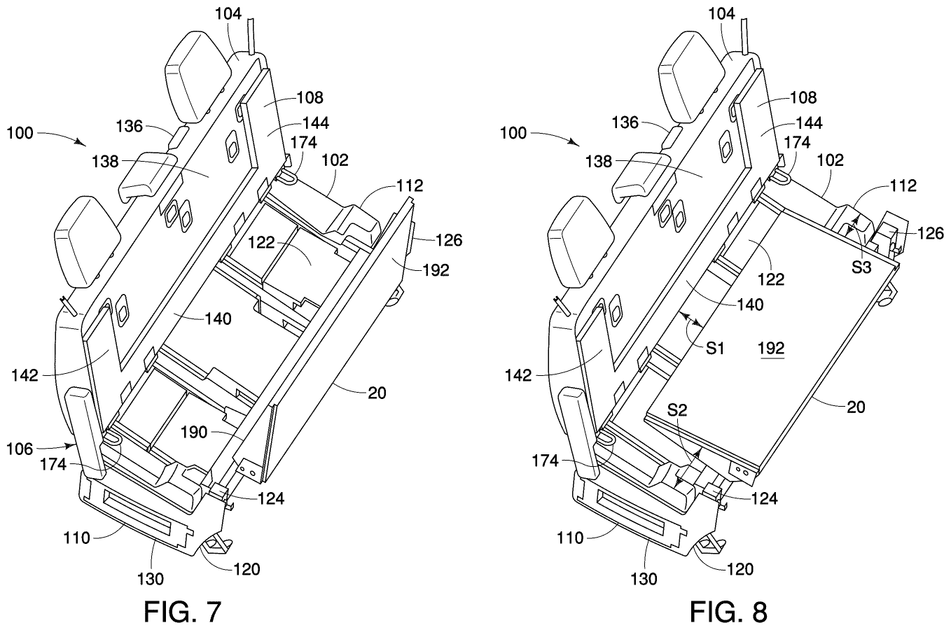

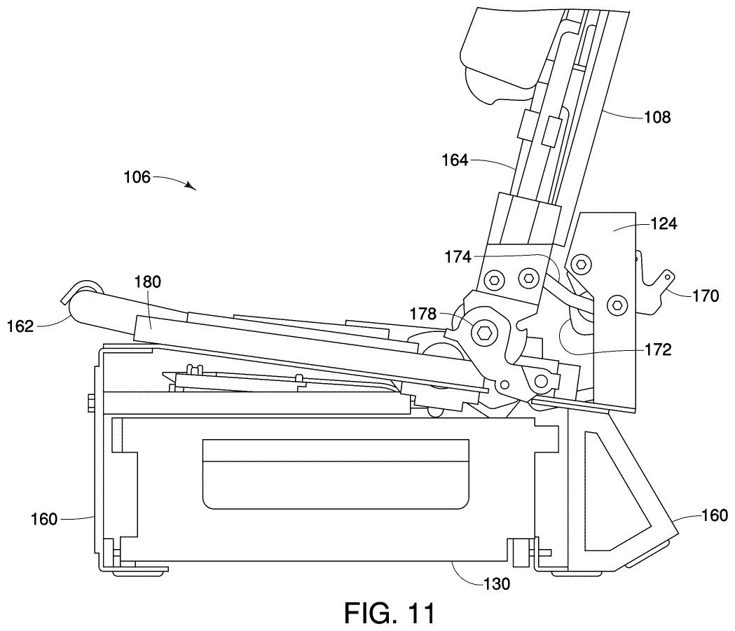

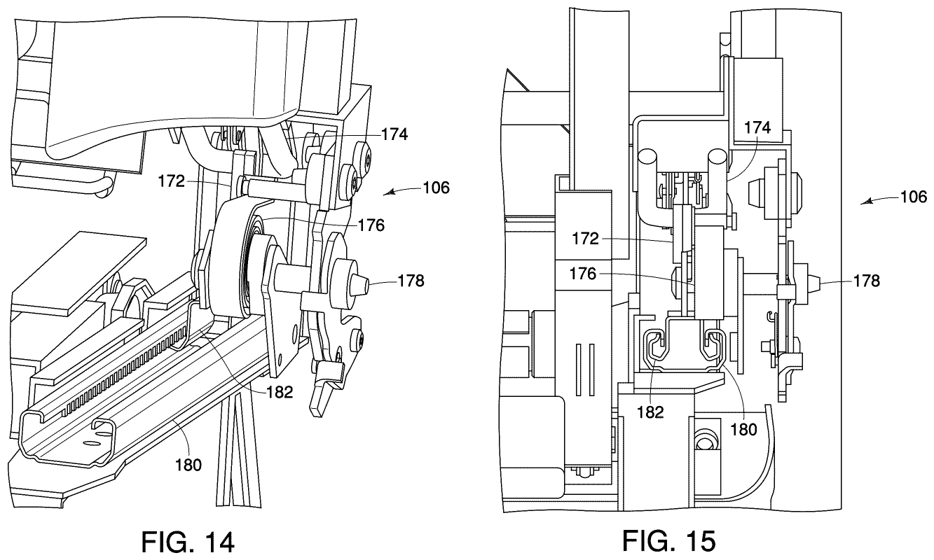

In FIG. 7, the seat backrest 104 has moved from the rearward configuration to the forward configuration. As described in more detail below with reference to FIGS. 11 to 15, the seat backrest 104 is configured to slide horizontally over the seat bottom 102 when moving between the forward configuration and the rearward configuration. The seat bottom 102 remains stationary while the seat backrest 104 moves from the rearward configuration to the forward configuration, and vice versa. In the relative configuration shown in FIG. 7, the midgate 20 is still closed.

In FIG. 8, the midgate 20 has moved from the closed configuration to the open configuration, creating an open space 24 between the passenger cabin 12 and the cargo bed 18 as seen in FIG. 4. Here, the midgate 20 has moved into the passenger cabin 12. More specifically, the midgate 20 is pivotally attached to the rest of the wall separating the passenger cabin 12 and the cargo bed 18, and the midgate 20 pivots into the passenger cabin 12 when moving from the closed configuration to the open configuration. Since the seat backrest 104 is in the forward configuration in the relative configuration shown in FIG. 8, the midgate 20 is able to move from the closed configuration to the open configuration without contacting the seat backrest 104. In the illustrated embodiment, the midgate 20 rests on the seat bottom 102 when in the open configuration. Here, the midgate 20 rests on the upper surface 122 of the seat bottom 102, but the midgate 20 can also rest on or otherwise be supported by other elements such as the first support 124 and the second support 126. In an alternative embodiment, the midgate 20 can also pivot away from the passenger cabin 12 and into the cargo bed 18 and/or rest on the cargo bed floor 22.

As also seen in FIG. 8, the midgate 20 is located above the seat bottom 102 when the midgate 20 is in the open configuration. The midgate 20 is not located above the seat backrest 104, but is instead located rearward of the seat backrest 104. Here, the size of the midgate 20 and the distance between the midgate 20 in the open configuration and the seat backrest 104 in the forward configuration forms a center space S1 between the midgate 20 and the seat backrest 104, a lateral space S2 between the midgate 20 and the first lateral side 110 of the seat assembly 100, and a lateral space S3 between the midgate 20 and the second lateral side 112 of the seat assembly 100.

In FIG. 9, the tray 108 has moved to cover the spaces S1, S2, S3 surrounding the midgate 20. More specifically, the tray 108 has pivoted from the seat backrest 104 toward the midgate 20 to cover the spaces S1, S2, S3. As seen in FIG. 9, the tray 108 is generally U-shaped and forms the edge surfaces of the rearward-facing seat when the tray 108 is down. More specifically, the tray 108 includes a U-shaped surface formed by a central platform 140 and two lateral side platforms 142, 144, which form a U-shaped upper surface 146 that surrounds a forward side and at least part of opposite lateral sides of the midgate 20 when the tray 108 is in the in-use configuration and the midgate 20 is in the open configuration. In other words, the central platform 140 covers the space S1 between the seat backrest 104 and the midgate 20, while each lateral side platform 142, 144 covers a respective lateral space S2, S3. In the configuration shown in FIG. 9, the first lateral side platform 142 rests on the first support 124, and the second lateral side platform 144 rests on the second support 126, providing stability to the tray 108 and allowing a load to be placed on top of the upper surface 146. A vehicle passenger can thus sit on the midgate 20 and/or the tray 108 with sufficient support. The midgate 20 and the tray 108 can also support cargo extending into the passenger cabin 12 from the cargo bed 18 and protect the cushioned seat bottom 102 from tears or other damage from such cargo.

As also seen in FIG. 9, the tray 108 includes hinges 148 to pivotally attach to the rear surface 138 of the vehicle seat 100. The hinges 148 can be spring-loaded hinges that bias the tray 108 into the stowed configuration against the seat backrest 104. The hinges 148 can also be spring-loaded hinges that bias the tray 108 towards the seat bottom 102. Here, the tray 108 pivots down from the rear surface 138 of the vehicle seat 100 in the opposite direction that the midgate 20 pivots into the passenger cabin 12 when moving from the closed configuration to the open configuration, allowing the midgate 20 and tray 108 to pivot separately in either order without hitting each other.

An operator then follows the reverse process to convert the vehicle seat 100 from the rearward-facing seat back to the forward-facing seat. That is, the operator or passenger pivots the tray 108 up toward the rear surface 138 of the backrest 104, and pivots the midgate 20 from the generally horizontal (open) configuration shown in FIG. 8 to the generally vertical (closed) configuration shown in FIG. 7. Since the seat backrest 104 is still in the forward configuration, the midgate 20 does not contact the seat backrest 104 when moving from the open configuration to the closed configuration. The operator or passenger can then slide the seat backrest 104 rearward over the seat bottom 102 while the seat bottom 102 remains in the same stationary position to finish reconfiguring the vehicle seat 100 as the forward-facing seat shown in FIGS. 5 and 6.

As seen in FIG. 10, the mechanisms used by the seat assembly 100 to move between the closed configuration and the open configuration enable the seat bottom 102 to further include a large storage drawer 130 within the inner storage space 128 of the base 110. That is, since the seat bottom 102 remains stationary while the seat backrest 104 moves between the forward configuration and the rearward configuration and while the midgate 20 moves between the closed configuration and the open configuration, the storage space 128 within the base 110 remains stationary regardless of the positioning of the seat backrest 104 and the midgate 20. The storage space 128 within the base 110 can therefore be accessed, and the storage drawer 130 positioned in the storage space 128 remains upright, regardless of the relative positioning of the other components of the vehicle seat 100. The storage drawer 130 can also be accessed from either side of the vehicle seat 100 regardless of the relative positioning of the other components of the vehicle seat 100. FIG. 10 shows the storage drawer 130 being extended out of the first lateral side 110 of the vehicle seat 100, and the storage drawer 130 can also extend out of the second lateral side 112 of the vehicle seat 100 in the same way. In the illustrated embodiment, the storage drawer 130 extends the entire width of the vehicle seat 100 between the first lateral side 110 and the second lateral side 112 and can be pulled past the first lateral side 110 and the second lateral side 112 in either lateral direction.

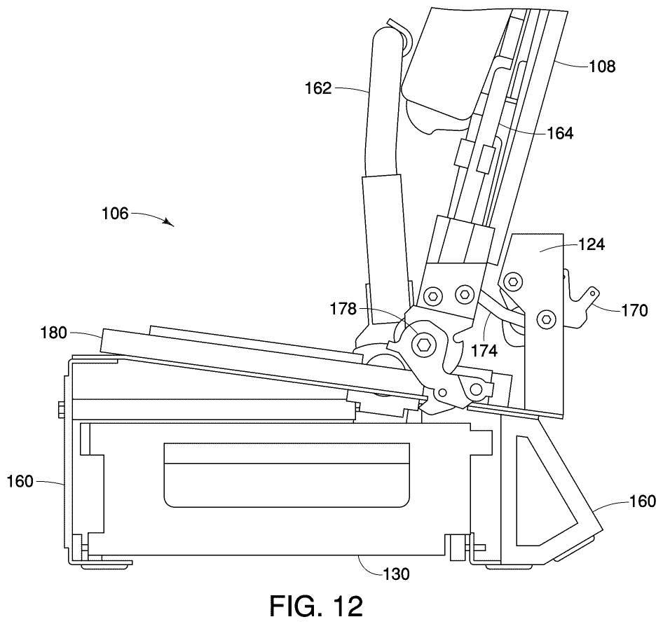

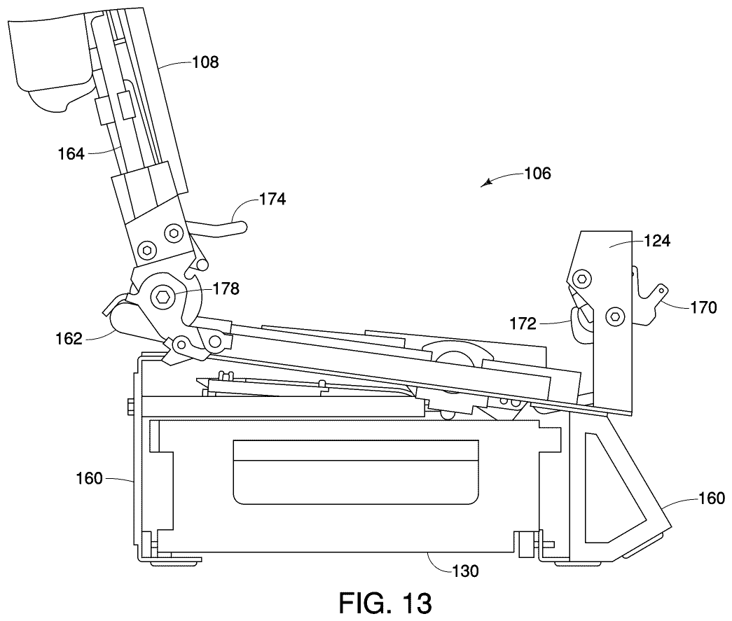

FIGS. 11 to 15 illustrate the movement mechanism 106 in more detail, with certain of the other parts of the vehicle seat 100 removed for convenience. FIG. 11 shows the components when the seat backrest 104 is in the rearward configuration and the seat bottom 102 is pivoted down. FIG. 12 shows these components when the seat backrest 104 is in the rearward configuration with the seat bottom 102 pivoted up, for example, to allow a person to access the storage space 128 within the base 120. FIG. 13 shows these components with the seat backrest 104 pivoted forward and moved into the forward configuration to form the rearward-facing seat. The configuration shown in FIG. 11 corresponds to the configuration shown in FIG. 6, while the configuration shown in FIG. 13 corresponds to the configuration shown in FIG. 7.

Referring first to FIGS. 11 to 13, the base 120 includes a base frame 160, the seat bottom 102 includes a bottom frame 162, and the seat backrest 104 includes a backrest frame 164. The backrest frame 164 is operatively connected to the bottom frame 162 by the base frame 160. The bottom frame 162 and the backrest frame 164 each also individually pivot with respect to the base frame 160. The bottom frame 162 and the backrest frame 164 also pivot with respect to each other.

As seen in FIGS. 11 to 15, the movement mechanism 106 generally includes one or more of a lever 170, a clasp 172, a holding mechanism 174, a biasing mechanism 176, an actuator 178, an elongated track 180 and a track cartridge 182. The lever 170 is configured to release the clasp 172 from the holding mechanism 174, which unlocks the seat backrest 104 so that the seat backrest 104 can move from the rearward configuration to the forward configuration. The biasing mechanism 176 is configured to bias the seat backrest 104 into a forward pivot toward the front side 14 of the passenger cabin 12, so that the seat backrest 104 is angled appropriately to act as the backrest for the rearward-facing seat when in the forward configuration. The actuator 178 is configured to release the track cartridge 182 from the elongated track 180, enabling the track cartridge 182 to move back and forth freely along the elongated track 180 towards either of the front side 14 or the rear side 16 of the passenger cabin 12. The backrest frame 164 is attached to the track cartridge 182 and moves with the track cartridge 182 along the elongated track 180. Those of ordinary skill in the art will recognize from this disclosure that certain components of the movement mechanism 106 can be modified, omitted or added without departing from the spirit or scope of the present disclosure.

To move the seat backrest 104 from the rearward configuration shown in FIG. 11 to the forward configuration shown in FIG. 13, a person initially actuates the lever 170 to release the holding mechanism 174 from the clasp 172. The lever 170 can further have a handle attached thereto. In the illustrated embodiment, the holding mechanism 174 is a U-shaped bar with its free ends operatively connected to the backrest frame 164 and its center portion projecting rearward and held by the clasp 172 when the seat backrest 104 is in its rearward configuration. In an embodiment, the vehicle seat 100 can include a second upper latch near the top of the seat backrest 104 that attaches to another part of the passenger cabin 12.

Once the holding mechanism 174 is released from the clasp 174 by actuation of the lever 170, the biasing mechanism 176 biases the seat backrest 104 to be angled towards the front side 14 of the vehicle cabin 12. In the illustrated embodiment, the biasing mechanism 176 is a tensioned spring coil which when released causes the seat backrest 104 to pivot forward to the angle shown in FIG. 13. A person then actuates the actuator 178 (e.g., presses an actuator button or pulls an actuator lever), which releases the track cartridge 182 from one or both sides of the elongated track 180 so that the track cartridge 182 is able to slide freely along the length of the elongated track 180. The person then pushes the seat backrest 104 forward toward the front side 14 of the passenger cabin 12. When the track cartridge 182 reaches its forward-most position within the elongated track 180, as seen in FIG. 13, the track cartridge 182 again locks into the elongated track 180 to lock the seat backrest 104 in the forward configuration. The vehicle seat 100 is then in the forward configuration shown in FIG. 7, and the midgate 20 and/or the tray 108 can be moved as shown in FIGS. 8 and 9 to form the rearward-facing seat.

To move the seat backrest 104 back from the forward configuration (e.g., FIGS. 7 and 13) to the rearward configuration (e.g., FIGS. 6 and 11), a person again actuates the actuator 178 to release the track cartridge 182 from one or both sides of the elongated track 180 so that the track cartridge 182 is able to slide freely along the length of the elongated track 180. The person then pushes the seat backrest 104 rearwards toward the rear side 16 of the passenger cabin 12. When the track cartridge 182 reaches its rearward-most position within the elongated track 180, as seen in FIG. 11, the track cartridge 182 again locks into the elongated track 180. A user can also pivot the seat backrest 104 rearward against the biasing force of the biasing mechanism 176 to again lock the holding mechanism 174 into the clasp 172. In an embodiment, the seat backrest 104 automatically pivots rearward as it is translated rearward along the elongated track 180.

It should be understood by those of ordinary skill in art from this disclosure that some or all of the parts of the movement mechanism 106 can be automated, such that the vehicle 10 can include a control panel or graphical user interface that allows a person to move the seat backrest 104 back and forth between the rearward configuration and the forward configuration without having to operate the lever 170 or the actuator 178 or otherwise having to physically push the seat backrest 104. For example, the elongated track 180 and/or the track cartridge 182 can include a motor that moves the track cartridge 182 along the elongated track 180 in the desired direction. The lever 170, the clasp 172, the holding mechanism 174, the biasing mechanism 176 and/or the actuator 178 can also be motor-operated for ease of use. Thus, in an embodiment, a person need only select, for example, forward-facing seat or rearward-facing seat on the control panel to cause the seat backrest 104 to translate over the upper surface 122 of the seat bottom 102 as shown and described herein. Movement of the midgate 20 and/or tray 108 can also be automated to automatically pivot these components between their respective configurations.

The sizes and shapes of the components of the vehicle seat 100 also facilitate the above-described processes. As seen in FIGS. 11 to 13, in the illustrated embodiment, the seat bottom 102 (and corresponding bottom frame 162) is generally angled downwardly from front to back, which is a preferred configuration for comfort in the forward-facing seat and allows passengers to sit on the seat bottom 102 without sliding forward. Since the seat bottom 102 remains stationary in the illustrated embodiment and does not change its angle when the seat backrest 104 moves to the forward configuration to create the rearward-facing seat, the seat bottom 102 remains angled downwardly from the front to rear as shown in FIGS. 7 and 13. To compensate for this angle, the midgate 20 is shaped to level out the rearward-facing seat. As seen in FIGS. 6 and 7, the midgate 20 can have a cross-section with a first surface 190 and a second surface 192 that are at an acute angle with respect to each other (i. e, not parallel). In the illustrated embodiment, the first surface 190 is the lower surface that contacts the seat bottom 102 when the midgate 20 is in the open configuration, and the second surface 192 is the upper surface that forms the bottom surface of the rearward-facing seat when the midgate 20 is in the open configuration. By configuring the midgate 20 with these two non-parallel surfaces 190, 192, the second surface 192 forms a generally horizontal seat bottom, as shown for example in FIGS. 4 and 9. FIG. 4 also shows that the midgate 20 can be configured so that the second surface 192 is approximately horizontally level with the cargo bed floor 22 when the midgate 20 is in the open configuration. The second surface 192 can also be configured to have a slight downward angle from rear to front, for example, generally the opposite downward angle of the seat bottom 102 in the forward-facing seat configuration. In the illustrated embodiment, the midgate 20 has a generally triangular cross-section that is thinner on the top side (see, e.g., FIG. 6), but the midgate 20 can also have a trapezoidal or other shape cross-section.

In alternative embodiments, the vehicle seat 100 and/or the midgate 20 can be configured to create a horizontal or optimally-angled surface in other ways. The midgate 20 can be configured to rest on another element besides the upper surface 122 of the seat bottom 102. For example, the first support 124 and the second support 126 can be positioned to support the weight of the midgate 20 in a preferred orientation, or the vehicle 10 can include supports located separately from the vehicle seat 100 that support the weight of the midgate 20 in a preferred orientation. The vehicle seat 100 can also include a separate part that is placed on top of the midgate 20 to achieve the preferred orientation and/or provide cushioning to the midgate 20 for the passenger to sit on. In another alternative embodiment, the seat bottom 102 can be configured to slightly adjust its angle depending on whether the vehicle seat 100 is in the forward-facing or reverse-facing orientation. In another embodiment, the midgate 20 can be configured to have multiple open configurations in which it is positioned differently.

The illustrated vehicle 10 is a pickup truck, but those of ordinary skill in the art will recognize from this disclosure that the mechanisms described herein can also be applied to other types of vehicles 10. For example, a vehicle seat 100 that moves between a forward-facing seat and a rearward-facing seat can be advantageous as a middle seat in an SUV, van or other vehicle because it enables passengers sitting on the seat to be positioned towards the front seats or the rear seats as desired. A vehicle seat 100 that moves between a forward-facing seat and a rearward-facing seat can be also be advantageous as a rear seat even in a vehicle without a cargo bed 18 to enable passengers sitting in the vehicle seat 100 to look rearward. Further still, the trunk of a vehicle 10 could replace the midgate 20 and form a seat bottom for a rearward-facing seat out of the rear side of a vehicle 10 as the midgate 20 does in the illustrated embodiment.

The embodiments described herein provide a vehicle seat 100 that can be converted from a forward-facing seat to a rearward-facing seat that is open to the outside of a vehicle 10. These systems and methods are advantageous, for example, because they maximize space and versatility of a vehicle cabin 12 and a cargo bed 18. It should be understood that various changes and modifications to the systems and methods described herein will be apparent to those skilled in the art and can be made without diminishing the intended advantages.

### General Interpretation of Terms

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts.

The term “configured” as used herein to describe a component, section or part of a device includes hardware and/or software that is constructed and/or programmed to carry out the desired function.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. A vehicle comprising:
a passenger cabin having a front side and a rear side;
a vehicle seat located inside the passenger cabin, the vehicle seat including a seat bottom and a seat backrest, the seat backrest configured to slide horizontally over the seat bottom to move between a forward configuration and a rearward configuration;
a cargo bed located on the rear side of the passenger cabin; and
a midgate located between the passenger cabin and the cargo bed, the midgate configured to move between (i) an open configuration in which the passenger cabin is open to the cargo bed, the seat backrest is in the forward configuration, and the midgate is located above the seat bottom, (ii) and a closed configuration in which the passenger cabin is closed off from the cargo bed by the midgate and the seat backrest is in the rearward configuration.

2. The vehicle of claim 1, wherein
the midgate pivots into the passenger cabin when moving from the closed configuration to the open configuration.

3. The vehicle of claim 1, wherein
the seat bottom remains stationary when the seat backrest moves between the forward configuration and the rearward configuration.

4. The vehicle of claim 1, wherein
the midgate does not contact the seat backrest when the midgate is in the open configuration and the seat backrest is in the forward configuration.

5. The vehicle of claim 1, wherein
the cargo bed includes a cargo bed floor, and
the midgate is approximately horizontally level with the cargo bed floor when the midgate is in the open configuration.

6. The vehicle of claim 1, wherein
the seat backrest and the seat bottom form a forward-facing seat facing the front side of the passenger cabin when the seat backrest is in the rearward configuration and the midgate is in the closed configuration, and
the seat backrest and the midgate form a rearward-facing seat facing the rear side of the passenger cabin when the seat backrest is in the forward configuration and the midgate is in the open configuration.

7. The vehicle of claim 1, wherein
the midgate rests on the seat bottom when the midgate is in the open configuration.

8. A vehicle comprising:
a passenger cabin having a front side and a rear side;
a cargo bed located on the rear side of the passenger cabin;
a midgate located between the passenger cabin and the cargo bed, the midgate configured to move between an open configuration in which the passenger cabin is open to the cargo bed and a closed configuration in which the passenger cabin is closed off from the cargo bed by the midgate; and
a vehicle seat located inside the passenger cabin facing the front side, the vehicle seat including a seat bottom and a seat backrest, the seat backrest configured to move with respect to the seat bottom so that the midgate is located above the seat bottom but not above the seat backrest when the midgate is in the open configuration.

9. The vehicle of claim 8, wherein
the seat bottom remains stationary while the seat backrest moves with respect to the seat bottom to permit the midgate to move from the closed configuration to the open configuration.

10. The vehicle of claim 8, wherein
the seat backrest moves over an upper surface of the seat bottom to permit the midgate to move from the closed configuration to the open configuration.

11. The vehicle of claim 8, wherein
the midgate pivots with respect to the passenger cabin when to moving from the closed configuration to the open configuration.

12. The vehicle of claim 8, wherein
the midgate moves into the passenger cabin when to moving from the closed configuration to the open configuration.

13. The vehicle of claim 8, wherein
the midgate rests on the seat bottom when the midgate is in the open configuration.

14. The vehicle of claim 8, wherein
the seat backrest is configured to move between a forward configuration and a rearward configuration,
the seat backrest and the seat bottom form a forward-facing seat facing the front side of the passenger cabin when the seat backrest is in the rearward configuration and the midgate is in the closed configuration, and
the seat backrest and the midgate form a rearward-facing seat facing the rear side of the passenger cabin when the seat backrest is in the forward configuration and the midgate is in the open configuration.

15. A vehicle comprising:
a passenger cabin having a front side and a rear side;
a cargo bed located on the rear side of the passenger cabin;
a midgate located between the passenger cabin and the cargo bed, the midgate configured to move between an open configuration in which the passenger cabin is open to the cargo bed and a closed configuration in which the passenger cabin is closed off from the cargo bed by the midgate; and
a vehicle seat located inside the passenger cabin, the vehicle seat including a seat bottom and a seat backrest, the seat backrest configured to move between a forward configuration and a rearward configuration,
the seat backrest and the seat bottom forming a forward-facing seat facing the front side of the passenger cabin when the seat backrest is in the rearward configuration and the midgate is in the closed configuration,
the seat backrest and the midgate forming a rearward-facing seat facing the rear side of the passenger cabin when the seat backrest is in the forward configuration and the midgate is in the open configuration.

16. The vehicle of claim 15, wherein
the midgate is located above the seat bottom when the midgate is in the open configuration.

17. The vehicle of claim 15, wherein
the midgate moves from the closed configuration to the open configuration without contacting the seat backrest when the seat backrest is in the forward configuration.

18. The vehicle of claim 15, wherein
the seat bottom remains stationary while the seat backrest moves from the rearward configuration to the forward configuration.

19. The vehicle of claim 15, wherein
the midgate pivots into the passenger cabin when moving from the closed configuration to the open configuration.

20. The vehicle of claim 15, wherein
the midgate rests on the seat bottom when the midgate is in the open configuration.
